(19) United States
(12) Patent Application Publication
(10) Pub. No.: US 2015/0065259 A1
(43) Pub. Date: Mar. 5, 2015

(54) COMPLIANT CONSTANT VELOCITY CONSTANT TORQUE UNIVERSAL JOINT

(71) Applicant: Flexous B.V., Delft (NL)

(72) Inventors: Davood Farhadi Machekposhti, Sari (IR); Nima Tolou, The Hague (NL)

(73) Assignee: Flexous B.V., Delft (NL)

(21) Appl. No.: 14/014,119

(22) Filed: Aug. 29, 2013

(51) Int. Cl. F16D 3/10

(52) U.S. Cl. CPC F16D 3/10
USPC 464/81

(57) ABSTRACT

A compliant constant velocity constant torque universal joint to transmit a rotary movement between two angled shafts, and/or a kinematic pair with two independent rotational degrees of freedom. This compliant structure is a large deflection compliant joint and the misalignment angle can be changed through the range of from 0° to 60°. The mechanism includes at least three compliant or statically balanced compliant spatial 4R (four revolute joint) linkages connected between two shafts, each system including four compliant joint axes and three rigid or compliant link members. The joint axes in each system are mounted so that each axis intersects one other joint axis. The compliant system is symmetrical about a plane which bisects two shaft axes perpendicularly.

### BACKGROUND OF THE INVENTION

1. Field of the Invention

The present invention relates to constant velocity universal joints and flexible coupling for joining the ends of rotatable shafts which are subject to axial misalignment to achieve a more constant angular velocity transfer between shafts. Moreover, it relates to multiple degrees of freedom joints which present at least two rotational degrees of freedom.

2. Description of the Related Art

Many applications require a mechanism to transmit rotation from one direction to another direction with constant velocity and constant torque. The primitive and traditional method to solve the problem of rotation transmission was Hooke's universal joint. A Hooke's universal joint includes three similar sets of four-bar spherical linkages which move in synchrony. However, Hooke's universal joint has a non-constant velocity transfer function. As the angle between the two shafts increases, the variation in speed increases correspondingly, this causes increased stresses on the members of universal joint and a potentially destructive vibration on the driven shaft.

To overcome these problems, numerous constant velocity universal joints have been invented and developed to achieve constant angular velocity between two angled shafts. Examples include the Thompson constant velocity coupling disclosed in U.S. Pat. No. 7,442,126 and the Culver's constant velocity universal joint disclosed in U.S. Pat. No. 3,477,249. The Thompson constant velocity universal joint is designed based on Double Hooke's universal joint so that the length of intermediate shafts is zero and the coupling comprises a spherical parallelogram quadrilateral system as mechanical controller. This universal joint has spherical configuration and the misalignment angle can be varied up to 30° in this joint. The Culver constant velocity universal joint, has spatial configuration and comprising three similar set of spatial 4R linkage. In term of geometry, in each linkage system the first two joint axes have to intersect each other at reference point of corresponding shaft. Actually, each of the three axes of the system, comprising two first axis of spatial 4R linkage and rotation axis of corresponding shaft, intersect each other at one point. Generally, for whole mechanism there are 14 rotation axes so that 12 of them are joint axes and 2 of them are drive and driven shaft axes. Each 7 axes of whole system comprising 6 joint axis and one rotation axis of correspond shaft intersect each other at a reference point of corresponding shaft.

All of the presented constant velocity universal joints, such as above mentioned constant velocity universal joint, are rigid-body mechanisms. The rigid-body configuration has many disadvantages, such as wear, friction, backlash, being less cost effective and need for maintenance and assembling. Besides, they are sometimes needed inside a vacuum or wet environment. Therefore, it is difficult to use conventional bearings, due to the need of lubrication. The backlash in rigid-body mechanical connections also can become a problem in high precision engineering.

Moreover, numerous types of flexible couplings which are approximately constant velocity couplings have been invented to deal with problems that presented by rigid-body mechanisms. However, all of them have a small misalignment angle, often less than 5°, and they cannot transmit rotation with constant torque due to large axial stiffness.

Moreover, the monolithic nature of flexible coupling and compliant design also gives rise to a drawback: the elastic deformation of the monolithic structure requires significant force and energy which is considered a ‘necessary evil’ in compliant mechanism designs. In other words, the mechanical efficiency is poor, and it takes continuous force to hold the mechanism in position.

Hence, there is a need for a universal joint that does not have the disadvantages of wear, friction, backlash etc. To this end, there is a need for a high angularity flexible coupling that is capable of transmitting substantially constant velocity and substantially constant torque.

### SUMMARY OF THE INVENTION

This invention provides a novel and compact constant velocity universal joint with monolithic structure to deal with problems like wear, friction, backlash, assembling and need of lubrication in vacuum, harsh or wet environment. In one aspect, the present invention attempts to achieve a large deflection compliant universal joint which at the same time is able to transmit rotation from one direction to another direction with substantially true constant velocity and constant torque.

In one non-limiting example, the misalignment angle, the angle between input and output shafts, can be changed through a range of from approximately 0° to 60°; this universal joint transfer rotary movement with true or substantially true constant velocity throughout this range. The statically balanced types of this invention can transmit power between drive and driven shafts with true constant torque. This joint is capable to present two rotational degrees of freedom. The construction of the mechanism is simple and it can be fabricated from planar materials with motion that emerges out of the fabrication plan. Therefore, being fabricated in a plane, having a flat initial state and being monolithic are other advantages of this invention.

In one embodiment, at least three similar set of compliant or statically balanced compliant spatial 4R (four Revolute joint) linkages are arranged for interconnecting the drive and driven shafts. Each linkage system, in term of geometry, includes four joint axes and three rigid or compliant links. Each joint axis intersects one other joint axis and each of the two central joint axes intersects a corresponding first joint axis at an arbitrary point of the corresponding shaft. Therefore, all of joints and links can be prepared in a plane so that each linkage system can be fabricated in a plane. The central joint axes have a predetermined angle with respect to each other. The system, in one embodiment, is preferably substantially geometrically symmetrical about an imaginary plane called the homokinetic plane, which bisects the two shaft axes perpendicularly. The three links of each system in one embodiment are hingably connected, one between each intersecting set of first and central joint and another between the two central joint axes for maintaining the predetermined angle.

In one embodiment the invention comprises a joint for coupling a first and a second independent links the joint structure comprising a compliant linkage comprising: a first, a second, a third and a fourth compliant revolute joints that are respectively coupled between the first link and the second links wherein the first and fourth compliant revolute joints are respectively coupled to the first and second independent links and the second and third compliant revolute joints are respectively coupled to the first and fourth compliant revolute joints. This embodiment further comprises a coupler link that is connected between the second and the third compliant revolute joints wherein the second and third compliant revolute joints are arranged so that an axis of rotation of the second and third compliant revolute joints are symmetric about a homokinetic plane defined between the revolute joints.

In another embodiment the invention comprises a joint for coupling a first and a second independent link, the joint structure comprising a compliant linkage comprising a first, second, third and fourth compliant revolute joints that are respectively coupled between the first link and the second links wherein the first and fourth compliant joints are respectively coupled to the first and second independent links and the second and third compliant joints are respectively coupled to the first and fourth compliant joints; a coupler link that is connected between the third and the fourth compliant revolute joints. In this embodiment the invention further comprises a coupler link that is connected between the second and third compliant joints wherein the coupler link and the first through fourth compliant joints are formed so as to be substantially planar.

The aforementioned objects and advantages may be better understood by reference to the description taken in conjunction with the accompanying drawings.

### BRIEF DESCRIPTION OF THE DRAWINGS

FIG. 1 is a perspective view of one exemplary embodiment of a compliant spatial 4R linkage according to the present invention;

FIG. 2 is a side elevation view of the compliant spatial 4R linkage of FIG. 1;

FIG. 3 is an end elevation view of the compliant spatial 4R linkage of FIG. 1;

FIG. 4 is a perspective view of the Right-Circular Corner-Filleted (RCCF) compliant revolute joint;

FIG. 5 is a perspective view of a fully assembled compliant constant velocity universal joint between drive and driven shaft in accordance with the invention;

FIG. 6 is an end elevation view of a fully assembled compliant constant velocity universal joint;

FIG. 7 is a perspective view of a lamina form of the compliant spatial 4R linkage at fabrication plane;

FIG. 8 is a perspective view of a lamina form of the compliant spatial 4R linkage that emerges out of the fabrication plane;

FIG. 9 is a perspective view of a fully assembled lamina form of the invention;

FIG. 10 is a perspective view of the statically balanced compliant spatial 4R linkage with statically balanced compliant joints;

FIG. 11 is a perspective view of the statically balanced compliant spatial 4R linkage with statically balanced compliant joints with preloading;

FIG. 12 is a side elevation view of rolling contact joint which used as statically balanced compliant joint in FIG. 10;

FIG. 13 is a perspective view of statically balanced compliant joint which preloaded by linear or nonlinear spring that used as statically balanced compliant joint in FIG. 11;

FIG. 14 is a perspective view of the statically balanced compliant spatial 4R linkage which preloaded by cross axis linear or nonlinear springs;

FIG. 15 is a perspective view of the statically balanced compliant spatial 4R linkage which preloaded by a linear or nonlinear tension spring;

FIG. 16 is a perspective view of the statically balanced compliant spatial 4R linkage which preloaded by a bistable mechanism;

FIG. 17 is a side elevation view of bistable mechanism which used in FIG. 16;

FIG. 18 is a perspective view of another embodiment of a statically balanced compliant spatial 4R linkage which is preloaded by a spring mechanism;

FIG. 19 is a perspective view of another embodiment of a compliant spatial 4R linkage;

FIG. 20 is a perspective view of another embodiment of a complaint spatial 4R linkage;

FIG. 21 is a perspective view of one of the joints of the linkage of either FIG. 19 or 20; and

FIG. 22 is a cross-sectional view of a component of the joint of FIG. 21.

### DETAILED DESCRIPTION OF THE PREFERRED EMBODIMENT

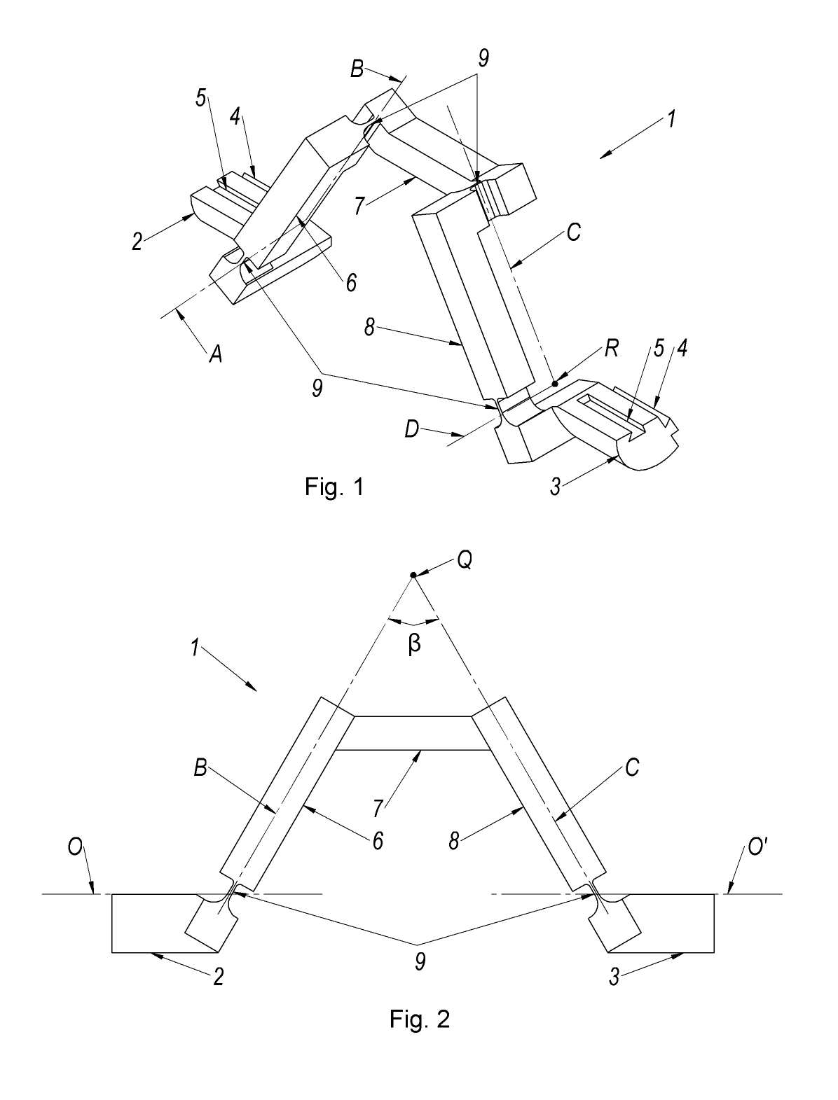

Reference will now be made to the drawings, wherein like numerals refer to like parts throughout. Referring to FIGS. 1-6, FIG. 1 illustrates one linkage 1 of a compliant constant velocity universal joint 10 which is shown in FIG. 5. As shown, the joint 10 includes a first independent link which can comprise a drive shaft 2 and a second independent link that can comprise—driven shaft 3. It will be apparent that while the linkage is described in conjunction with drive and driven shafts, the applicability of the current teachings can be applied between any two substantially rigid bodies. Pluralities of linkages 1 are assembled together in the manner shown in FIG. 5 to define the universal joint 10.

The drive shaft 2 is initially coupled to a cross link 40a that is attached to a crank link 6 via a first revolute joint 9a. The crank link 6 has a cross section 42a that is then connected to a coupler link 7 via a second revolute joint 9b. The coupler link 7 is then connected to a second crank link 8 via a third revolute joint 9c which connects to a cross section 42b of the second crank link 8. The second crank link 8 is connected to the second cross link 40b via a fourth revolute joint 9d. The second cross link 40b is then connected to the driven shaft 3 in a well-known manner. The exact configuration of the revolute joints 9a-9d will be described in greater detail below in reference to FIG. 4.

In operation, rotation of the drive shaft 2 results in rotational forces being exerted on the cross link 40a which induces rotational forces on the revolute joint 9a. The revolute joint 9a is designed to permit one degree of freedom about the rotational axis of the joint 9a between the kinematic pair of the cross link 40a and the crank link 6 thereby transmitting rotational forces from the cross link 40a to the crank link 6. The rotational forces on the crank link 6 are then transmitted via the revolute joint 9b via the cross section 42a. The cross section 42a results in the revolute joint 9b having an axis of rotation that intersects the axis of rotation of the revolute joint 9a. In one non-limiting example, the axis of rotation of the revolute joint 9b is perpendicular to the axis of rotation of the revolute joint 9a. The revolute joint 9b then transmits the force to the cross link 42b via the coupler link 7 and the cross link 42b transmits the rotational force to the second crank link 8 via the revolute joint 9c. The axis of rotation of the second revolute joint 9b and the third revolute joint 9c intersect each other with predetermined twist angle β. The second crank link 8 then transmits the rotational force via the revolute joint 9d to the cross link 40b and then to the driven shaft 3. The axis of rotation of the revolute joint 9d is intersects the axis of rotation of the third revolute joint 9c and can also be perpendicular thereto in another non-limiting example. This results in the rotational forces of drive shaft 1 being transmitted to the driven shaft 3 via the revolute joints 9a-9d. It will be appreciated that the cross links 40a, 40b and cross sections 42a, 42b can be removed without affecting the functionality of the system.

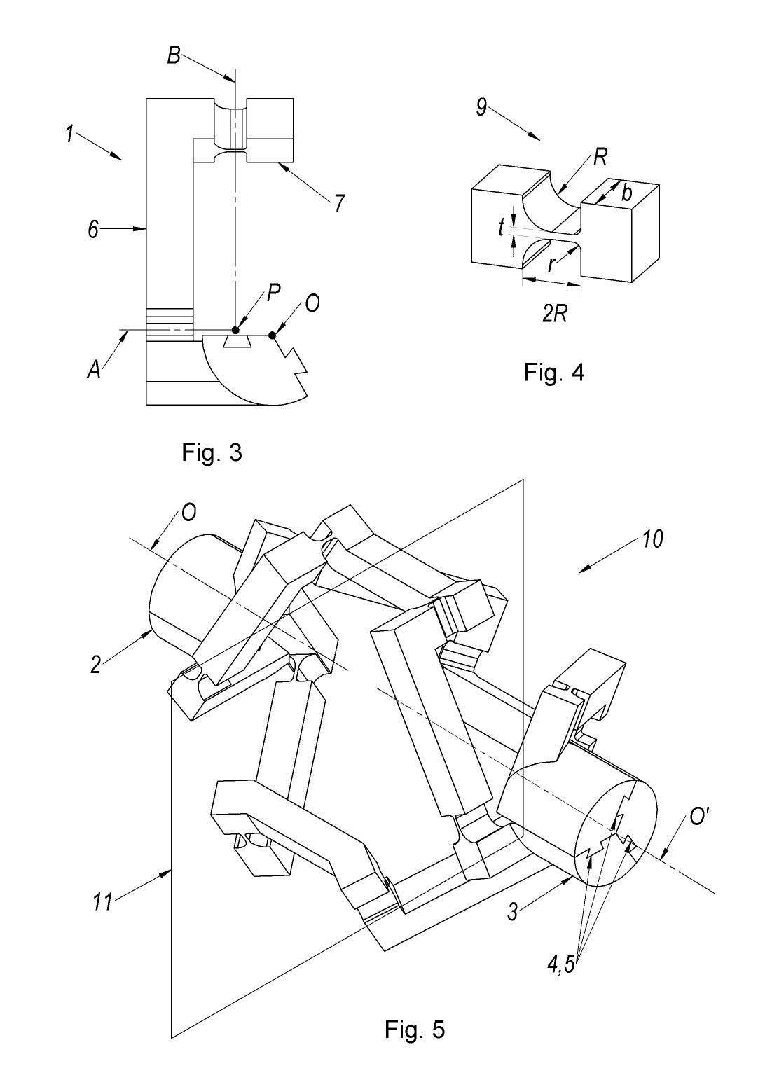

With reference to the compliant spatial 4R linkage 1 as illustrated in FIGS. 1, 2 and 3, the linkage system includes four compliant revolute joints 9a-9d, and their axes or rotation are A, B, C, and D, respectively. A compliant revolute joint is a joint that has a monolithic structure creating near pure rotational motion and has one dominating rotational axis. There is some small amount of off-axis motion due to compliancy. Moreover, the linkage system includes two crank links 6 and 8, and a coupler link 7 which connected hingably by means compliant revolute joints 9a-9d. The joint axes A and B of the first and second compliant revolute joints, 9a and 9b, are intersected and perpendicular to each other at point P (shown in FIG. 3). The two central joint axes B and C of the second and third compliant revolute joins, 9b and 9c, intersect each other at point Q (shown in FIG. 2) with predetermined twist angle β and they are parallel when the twist angle β is zero; and finally the joint axes C and D of the third and fourth compliant revolute joints, 9c and 9d, are intersected and perpendicular to each other at point R.

According to the FIG. 3, the joint axes, A and B, of the first and second compliant revolute joints can intersect each other at an arbitrary point P and it is not essential to intersect each other at the drive shaft axis O. In the same manner, this property is considered for joint axes, C and D, of the third and fourth compliant revolute joints at point R and respect to the driven shaft axis O′. However, there is an axis drift for compliant revolute joints 9a-9d, i.e., the travel of the center of rotation of compliant revolute joints, when the whole system is transferring the rotation. Therefore, when the universal joints 10 or 16 are rotating, the intersection points P will not be fixed respect to the drive shaft axis O, and also the intersection point R will not be fixed respect to the driven shaft axis O′. However this amount of translation of intersection points are very small and depend on the axis drift of used compliant revolute joints. Because the joint axes likewise intersect each other, the axis drift cannot change the kinematic properties of the whole system.

From FIGS. 1 and 5, the core 4 and the cavity 5 are mounted for connecting three sets of links 1.

FIGS. 1-3 illustrate a compliant linkage that has the crank members 6, 8. It will, however, be appreciated that the crank members 6, 8 are not required for the functionality of the linkage 1. FIG. 4 illustrates an exemplary revolute joint 9. As shown, each revolute joint comprises two openings 51a and 51b that have a right circular radius R and a fillet radius r. The revolute joints 9 also define a thickness b and a narrow thickness t between the two openings 51a, 51b. The revolute joint 9 shown in FIG. 4 comprises a Right Circular Corner Filleted (RCCF) structure although a person of ordinary skill in the art will appreciate that any of a number of different structures can be used to permit rotational motion with a very small axis drift.

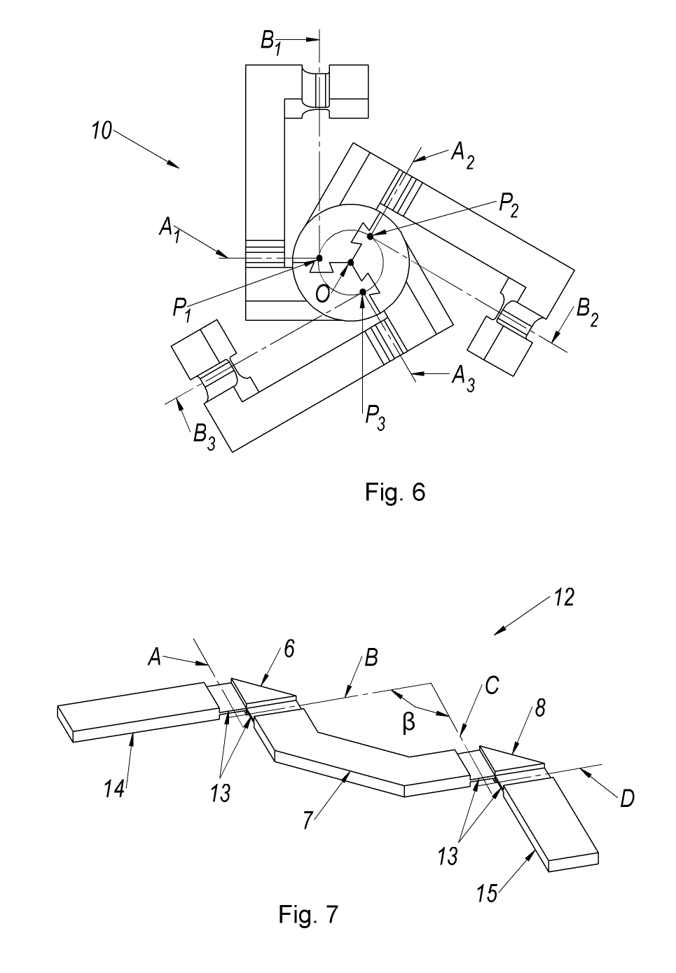

FIGS. 5 and 6 illustrate a perspective view and elevation view of a fully assembled compliant constant velocity universal joint 10 between drive shaft 2 and driven shaft 3 so that three similar sets of compliant spatial 4R linkage 1 are spaced 120° apart from each other and arranged by means core 4 and cavity 5, and all three linkage systems 1 are common in rotation axes O and O′. As shown in FIG. 5, the universal joint is symmetrical about homokinetic plane 11 which bisects the two shaft axes O and O′ perpendicularly. It will be appreciated that the kinematic properties of both sides of the homokinetic plane 11 should be the same to facilitate the transmission of the rotation with constant velocity. Different types of compliant joints can be used on different sides of the homokinetic plane 11, however, the position of the revolute joints and t heir axis should be symmetrical with respect to the other side. From FIG. 6, the joint axes A₁ and B₁, and the joint axes A₂ and B₂, and the joint axes A₃ and B₃ intersect each other at points P₁, P₂ and P₃, respectively, which these points are mounted in an arbitrary distance from shaft axis O and on circumference of a circle which indicates that the three sets of linkages are similar to each other.

FIG. 7-9 illustrate an alternate embodiment of a compliant joint where the function of the linkage is similar to the linkage described above in connection with FIGS. 1-6, but the structure of the linkage itself is different. As shown, the linkage 12 in FIG. 7 is comprised of a planar linkage comprised of a first and second connecting links 14, 15 that are designed to be respectively connected to a drive shaft 2 and driving shaft 3 in the manner shown in FIG. 9. The coupling links 14, 15 are coupled to crank links 6 and 8 by resolute joints 13a, 13d respectively. The crank links 6 and 8, in this embodiment are generally triangular in shape but can be any shape. The crank links 6 and 8 are respectively coupled to a coupling link 7 via resolute joints 13b and 13c.

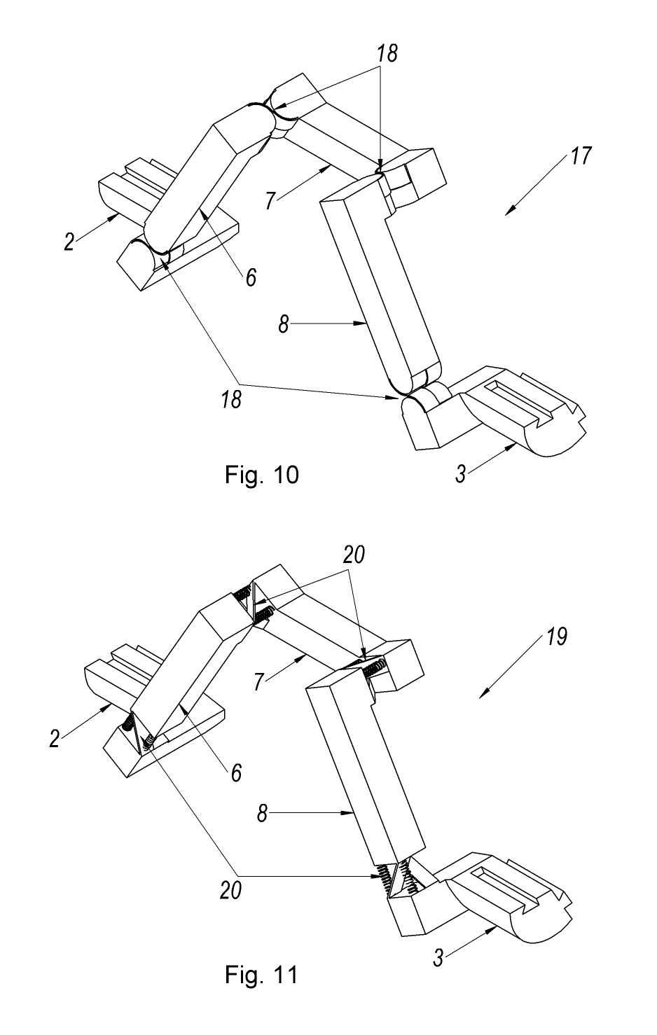

In the linkage system 12 as illustrated in FIG. 7, all of joints 13 and links 6, 7 and 8 can be prepared in a plane so that the linkage system 12 can be fabricated in a plane as lamina form of the compliant spatial 4R linkage. The compliant revolute joints 13a-d are simple leaf springs and it can be any compliant joints that can be prepared in a plane such as Right-Circular Corner-Filleted compliant revolute joint 9 or a rolling contact joint 18 which is discussed below in connection with FIG. 10. As shown in FIG. 7, the joint axes A and B perpendicular to each other at point P, the joint axes B and C intersect each other at point Q with predetermined angle β and the joint axes C and D perpendicular to each other at point R.

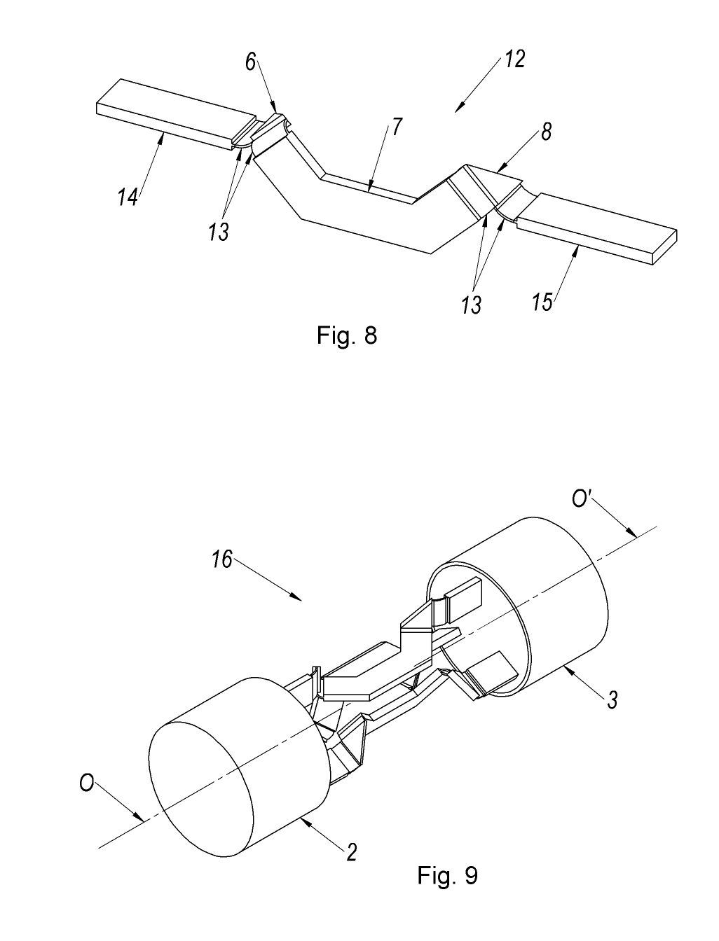

The connecting links 14 and 15 are designed as a core to prepare a rigid connection for linkage system 12 with drive shaft 2 and driven shaft 3 in the manner shown in FIG. 9. More specifically, the drive shafts 2 and 3 can comprise hollow cylinders having inner walls 55 to which the connecting links 14 and 15 can be attached. FIG. 8 illustrates a perspective view of a lamina form of the compliant spatial 4R linkage 12 that emerges out of the fabrication plane. FIG. 9 shows a perspective view of a fully assembled lamina form of the invention 16 so that the system comprising three sets of laminate compliant spatial 4R linkages 12 which are spaced 120° apart from each other and has rigid connection with the drive shaft 2 and the driven shafts 3 by the connecting links 14 and 15, respectively, and all three linkage systems 12 are common in rotation axes O and O′ in fully assembled system 16.

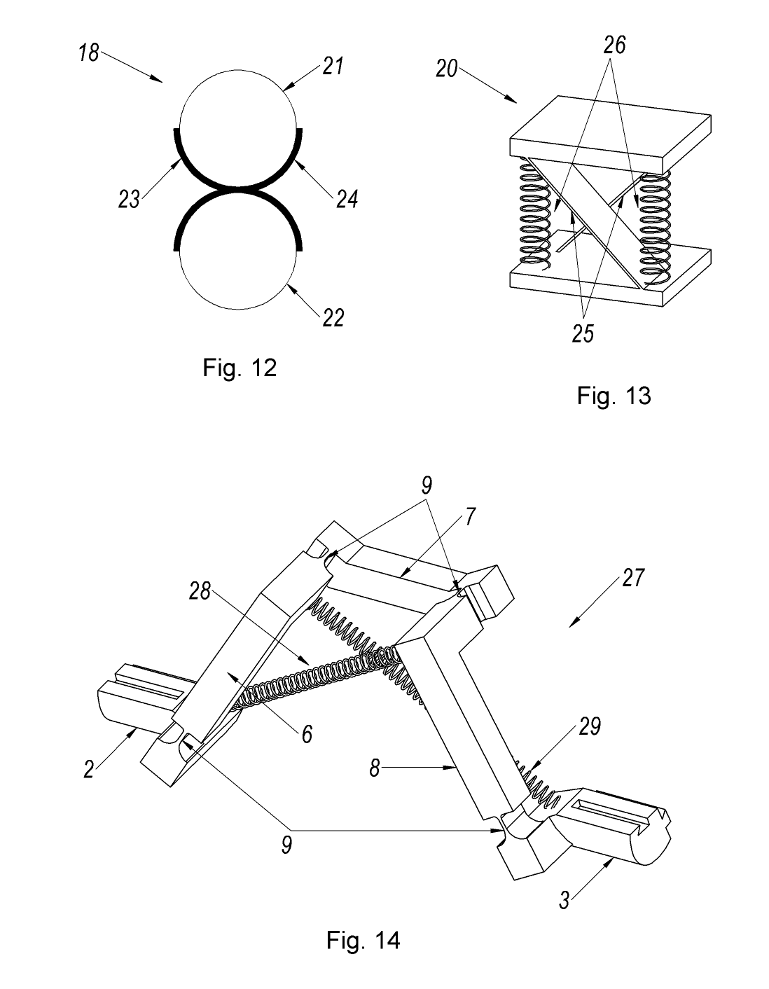

FIGS. 10 and 12 illustrate a configuration of a linkage 17 where the compliant joints 18a-d comprise rolling contact joints 18. A rolling contact joint 18 is a joint that has two rolling bodies 21, 22 that engage with each other and have straps 23 and 24 that hold the two rolling bodies 21, 22 together. In one implementation, the rolling joint is composed of two surfaces, e.g., two cylinders, rolling without slipping on each other. In this case, the two surfaces are cylinders of the same radius. But it is not essential and the surfaces can have different radius. The two surfaces are attached to each other by thin straps. These straps allow rolling contact, but prevent the surfaces from sliding or the two parts of the joint from separating. The straps can wrap over one or the other part of the joint. Both parts roll without sliding, therefore there is little or no energy loses due to friction so that the torque will become constant. An exemplary rolling contact joint is described in U.S. Pat. No. 3,932,045 to Hillberry et al. which is hereby incorporated by reference in its entirety. Advantageously, the straps 23 and 24 are preferably resilient which stores energy as a result of torque upon the joint. This can result in the joint being more statically balanced with near zero stiffness or zero stiffness.

More specifically, the straps 23 and 24 counter the rotational forces on the joint and the energy is stored in the resiliency of the strap 23 and 24 which inhibits the effect of torque on the links 6 and 8 and maintains the links 6 and 8 in a desired orientation which reduces the stiffness of the structure. The stiffness of spring 26 compensates the positive stiffness of compliant cross axis revolute joints 20 so that a more statically balanced compliant spatial 4R linkage 19 achieved. Therefore, a compliant constant velocity constant torque universal joint can be achieved if at least one compliant spatial 4R linkage of constant velocity universal joint 10 or 16 be presented as statically balanced compliant spatial 4R linkage 19.

The pre-loading of the linkage can also be achieved by arranging counter-loading members between the various links of the linkage. FIG. 14 illustrates an example of this where a linkage 27, which is similar to the linkage 1 and 12 described above includes preloaded cross axis linear or non-linear springs 28 and 29 that respectively extend between the drive shaft 2 and the top of the crank link 8 and the driven shaft 3 and the top of the crank link 6. The stiffness of springs 28 and 29 compensate the positive stiffness of compliant spatial 4R linkage so that a more statically balanced compliant spatial 4R linkage 27 achieved. Therefore, we can achieve a compliant constant velocity constant torque universal joint if at least one of compliant spatial 4R linkages of constant velocity universal joint 10 or 16 be presented as statically balanced compliant spatial 4R linkage 27.

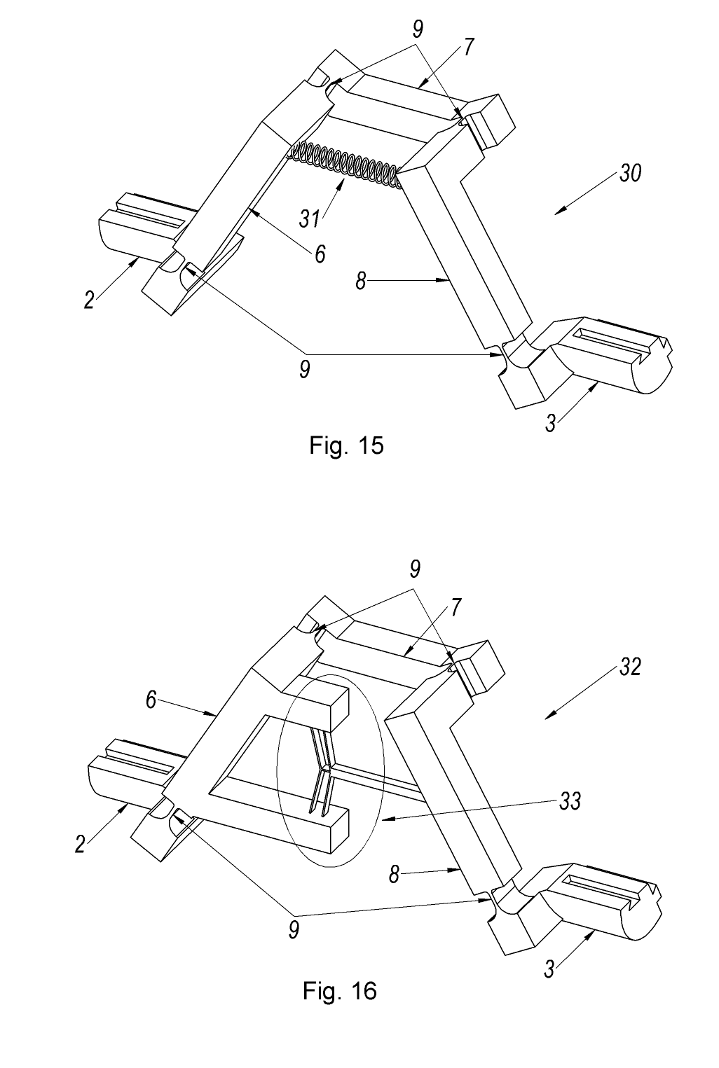

FIG. 15 illustrates another embodiment of a statically balanced form of compliant spatial 4R linkage 30 similar to the linkage 1 or 12 described above which preloaded by a linear or nonlinear tension spring 31 that connects the crank links member 6 and 8. In this embodiment, the tension spring 31 extends between the upper ends of the crank links 6 and 8 but a person of ordinary skill in the art will appreciate that the exact position of the spring 31 can vary without departing from the spirit and scope of the present teachings. The stiffness of spring 31 compensates the positive stiffness of compliant spatial 4R linkage 1 or 12 so that a statically balanced compliant spatial 4R linkage 30 achieved. Therefore, we can achieve a more compliant more constant velocity constant torque universal joint if at least one of compliant spatial 4R linkages of constant velocity universal joint 10 or 16 be presented as statically balanced compliant spatial 4R linkage 30.

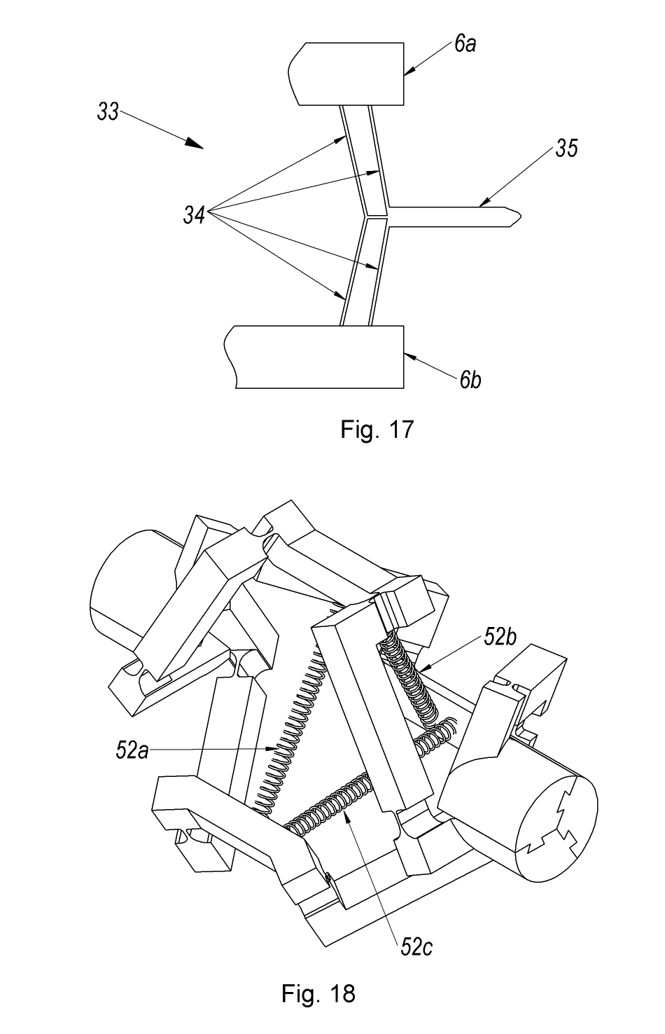

FIG. 16 illustrates another embodiment of a statically balanced form of compliant spatial 4R linkage 1 or 12 which preloaded by a bistable mechanism 33. As shown in this figure and FIG. 17, the bistable mechanism connecting embodiments 6 and 8 and comprising a pair of stationary pads 6a and 6b that are attached to the crank link 6, leaf springs 34 and a movable shuttle 35 which has a rigid connection with crank link 8. The negative stiffness of bistable mechanism 33 compensates the positive stiffness of compliant spatial 4R linkage 1 or 12 so that a statically balanced compliant spatial 4R linkage 32 achieved. Therefore, we can achieve a more compliant constant velocity constant torque universal joint if at least one of compliant spatial 4R linkages of constant velocity universal joint 10 or 16 be presented as statically balanced compliant spatial 4R linkage 32.

FIG. 18 illustrates that springs 52a, b, and c can be extended between the plurality of linkages 1 also to counter load the stiffness of the joints 9 of the linkage and also to increase torsional stiffness of the structure while countering the stiffness of the joints. It will be apparent that any number of different configurations of resilient members that counteract the force exerted by the joints can be implemented to achieve the more balanced joint without departing from the spirit of the present invention.

The statically balanced embodiments described herein allow for the linkage to have negative pre-loading on the compliant joints that ideally offset the load that the joints will experience when torque is being transmitted from the drive access to the driven access. The pre-loading devices can either be fixed or can be adjustable depending upon the implementation.

In this description, the linkages have been described as compliant linkages and are formed of non-rigid body materials that have compliant joints. A compliant mechanism is generally understood to be a monolithic structure that transfers motion, force or energy by using elastic deformation of its flexure joint rather than using rigid-body joints only. In these implementations, the compliant joints are formed of materials that have enough elastic deformation to be compliant. Possible materials include carbon nanotubes, titanium (e.g., grade 5), plastic, stainless steel, spring steel acrylic, polypropylene, silicon etc.

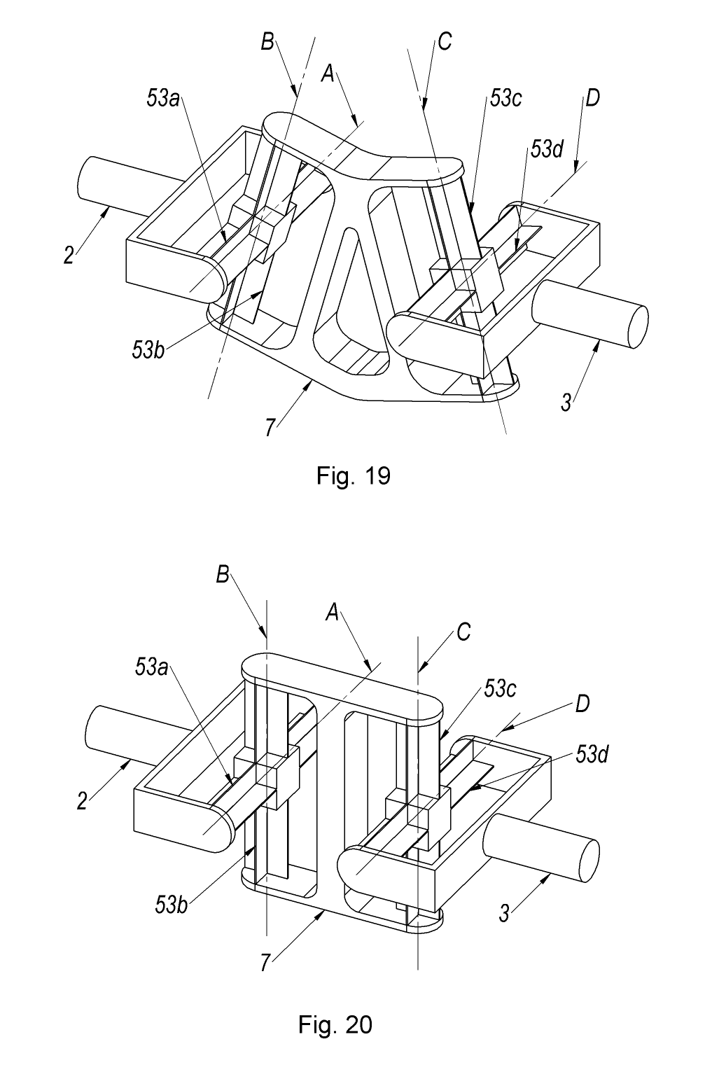

FIGS. 19 through 22 illustrates embodiments where the first and fourth compliant resolute joints 9a, 9d are directly coupled to the second and third resolute joints 9b and 9c.

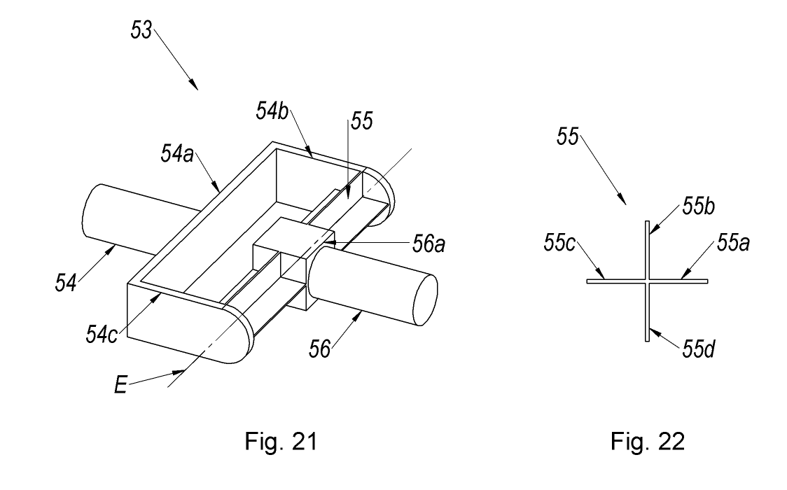

As shown in FIGS. 21 and 22 another one of compliant revolute joints can be a compliant cross revolute joint 53. This compliant joint includes two rigid-bodies 54 and 56 which are connected with compliant cross member 55. This structure poses a rotational motion between rigid bodies 54 and 56 via compliant cross member 55 around the rotational axis E. The compliant cross structure 55 comprises four leaf springs 55a-55d that arranged as cross configuration, as you can see in FIG. 22. The cross section 54b and 54c of the yoke 54 is mounted in two ends of the compliant cross structure 55. The rigid-body 56a of the embodiment 56 is fixed in the middle of compliant cross structure 55 and divides the compliant cross structure into two equal sections. When the embodiment 54 is fixed, by applying a torque on the embodiment 56 around the joint axis E the embodiment 56 and in the same manner the embodiment 56a can rotate around the axis E. Because the embodiment 54 is fixed during the rotation, the two end of compliant cross structure 55 is fixed with cross section 54b and 54c. Therefore, the embodiment 56a can rotate via torsional elastic deformation of leaf springs 55a-55d which have fix ends in the other side.

By using the compliant revolute joint 53 in the compliant structure 1 we have a compliant constant velocity universal joint as you can see in FIG. 19. As shown in this figure, the joint includes a drive shaft 2 and a driven shaft 3. The drive shaft 2 is initially coupled to the coupler link 7 via first and second compliant revolute joint 53a and 53b that are connected to each other as their rotation axes A and B intersect and perpendicular to each other. The coupler link 7 is then connected to the driven shaft 3 via third and fourth compliant revolute joint 53c and 53d that are connected to each other as their rotation axes C and D intersect and perpendicular to each other. The linkage system includes four compliant revolute joints 53a-53d, and their axes are A, B, C, and D, respectively. The joint axes A and B are intersected and perpendicular to each other. The two central joint axes B and C intersect each other at with predetermined twist angle β; and the joint axes C and D are intersected and perpendicular to each other in a well-known manner.

When the twist angle beta is zero in the compliant constant velocity universal joint (FIG. 19), the system is similar to a conventional rigid-body constant velocity universal joint that called Double Hooke's universal joint. As shown in FIG. 20, the joint axis B of the second compliant revolute joint is parallel to the joint axis C of the third compliant revolute joint. There is a shortcoming in this configuration (rigid-body Double Hooke universal joint, FIG. 19 and FIG. 20) and that is they have small misalignment angle actually smaller than 10 degrees.

The statically balanced embodiments described herein allow for the linkage to have negative pre-loading on the compliant joints that ideally offset the load that the joints will experience when torque is being transmitted from the drive access to the driven access. The pre-loading devices can either be fixed or can be adjustable depending upon the implementation.

In this description, the linkages have been described as compliant linkages and are formed of non-rigid body materials that have compliant joints. A compliant mechanism is generally understood to be a monolithic structure that transfers motion, force or energy by using elastic deformation of its flexure joint rather than using rigid-body joints only. In these implementations, the compliant joints are formed of materials that have enough elastic deformation to be compliant. Possible materials include carbon nanotubes, titanium (e.g., grade 5), plastic, stainless steel, spring steel acrylic, polypropylene, silicon etc.

The foregoing discussion has shown, illustrated and described various features, uses and characteristics of one embodiment of the present invention. It will, however, be appreciated to a person of ordinary skill in the art that various changes, substitutions and uses may be made by those skilled in the art without departing from the spirit and scope of the present invention. Hence, the scope of the present invention should not be limited to the foregoing discussion but should be defined by the appended claims.

What is claimed is:

1. A joint for coupling a first and a second independent links the joint structure comprising a compliant linkage comprising:
a first, a second, a third and a fourth compliant revolute joints that are respectively coupled between the first link and the second links wherein the first and fourth compliant revolute joints are respectively coupled to the first and second independent links and the second and third compliant revolute joints are respectively coupled to the first and fourth compliant revolute joints;
a coupler link that is connected between the second and the third compliant revolute joints;
wherein the second and third compliant revolute joints are arranged so that an axis of rotation of the second and third compliant revolute joints are symmetric about a homokinetic plane defined between the revolute joints.

2. The joint of claim 1, wherein the joint structure defines a plurality of compliant linkages.

3. The joint of claim 2, wherein the joint structure comprises three compliant linkages that are interconnected to each other and are spaced 120 degrees from each other.

4. The joint of claim 1, wherein the second compliant revolute joint and the third compliant revolute joint each define an axis that intersect with each other and define a predetermined twist angle β that is between approximately 0 and 180 degrees.

5. The joint of claim 1, wherein the first through fourth compliant revolute joints comprise Right Circular Corner Filleted (RCCF) joints.

6. The joint of claim 1, wherein the joint linkages are planar.

7. The joint of claim 6, wherein a first crank member is interposed between the first and second compliant revolute joints and a second crank member is interposed between the third and fourth compliant revolute joint.

8. The joint of claim 7, wherein the first and second crank links, the coupler link and the first through fourth compliant joints are formed so as to be substantially planar.

9. The joint of claim 8, wherein the first through fourth compliant revolute joints comprise leaf springs.

10. The joint of claim 1, further comprising an interconnection system that exerts force against the compliant linkage that offsets the stiffness induced by compliant linkage.

11. The joint of claim 10, wherein at least some of the first through fourth compliant revolute joints include resilient interconnection members that oppose the force exerted on the joints by the linkage as a result of transferring torque from the first independent link to the second independent link.

12. The joint of claim 11, wherein the resilient interconnection members exert negative stiffness against the first through fourth compliant revolute joints in opposition to positive stiffness exhibited by the joints.

13. The joint of claim 12, wherein the first through fourth compliant joints in combination with the resilient interconnection members exhibit substantially reduced stiffness behavior.

14. The joint of claim 11, wherein the first through fourth compliant revolute joints comprise rolling contact joints including rolling bodies that are in rolling contact with each other and resilient members that interconnect the rolling bodies so as to oppose the rolling motion of the rolling bodies.

15. The joint of claim 11, wherein the first through fourth compliant revolute joints comprise leaf spring interposed between two surfaces and wherein the first through fourth compliant revolute joint further are preloaded through linear or non-linear springs between the two surfaces that exert an opposite force of the force imposed on the leaf spring as a result of transmission of torque.

16. The joint of claim 11, wherein one or more linear or non-linear springs are attached between the linkage members exert force in opposition to the force exerted on the linkage as a result of torque being transmitted via the linkage from the first independent link to the second independent link.

17. The joint of claim 16, wherein a first crank member is interposed between the first and second compliant revolute joints and a second crank member is interposed between the third and fourth compliant revolute joint. the springs with linear or nonlinear behavior extend between the first independent link and the second crank link and the second independent link and the first crank link.

18. The joint of claim 17, wherein the one or more spring is coupled between the first and second crank link.

19. The joint of claim 18, wherein the first crank link includes a first and a second pad and a leaf spring is coupled between the first and second pad and wherein a movable shuttle is coupled to the leaf spring and engages with the second crank link.

20. The joint claim 4, wherein the twist angle β is zero

21. The joint of claim 1, wherein the structure has distributed compliance.

22. The joint of claim 1, wherein the first and second independent links respectively comprise a drive and a driven shaft.

23. The joint of claim 1 wherein the first through fourth compliant revolute joints are arranged so that an axis of rotation of the first and second compliant revolute joints intersect each other at first location and an axis of rotation of the third and fourth compliant revolute joints intersect each other at second location that are respectively offset from the axis of rotation of the first and second independent links.

24. The joint of claim 1, wherein the joint comprises a plurality of compliant linkages and each compliant linkage is connected to each other with one or more springs with linear or nonlinear behavior.

25. The joint of claim 1, wherein the first through fourth compliant revolute joints include leaf spring members and wherein the second and third compliant revolute joints are attached to the leaf spring members of the first and fourth compliant revolute joints and wherein the coupler link is coupled to the leaf spring members of the second and third compliant revolute joints.

26. A joint for coupling a first and a second independent link, the joint structure comprising a compliant linkage comprising:
a first, second, third and fourth compliant revolute joints that are respectively coupled between the first link and the second links wherein the first and fourth compliant joints are respectively coupled to the first and second independent links and the second and third compliant joints are respectively coupled to the first and fourth compliant joints; a coupler link that is connected between the third and the fourth compliant revolute joints;
a coupler link that is connected between the second and third compliant joints;
wherein the coupler link and the first through fourth compliant joints are formed so as to be substantially planar.

27. The joint of claim 26 wherein the second and third compliant revolute joints are arranged so that an axis of rotation of the second and third compliant revolute joints intersects an axis of rotation of the first and fourth compliant revolute joints at a first and a second location.

28. The joint of claim 27 wherein the first and second locations are respectively offset from the axis of rotation of the first independent link and the second independent link.

29. The joint of claim 28, wherein the joint structure defines a plurality of compliant linkages.

30. The joint of claim 26, wherein the joint structure comprises three compliant linkages that are interconnected to each other and are spaced 120 degrees from each other.

31. The joint of claim 26, wherein the second compliant revolute joint and the third compliant revolute joint respectively define an axis that intersect with each other and define a predetermined twist angle β that is between approximately 0 and 180 degrees.

32. The joint of claim 26, wherein the first through fourth compliant revolute joints comprise Right Circular Corner Filleted (RCCF) joints.

33. The joint of claim 27, wherein the first through fourth compliant revolute joints comprise leaf springs.

34. The joint of claim 26, further comprising an interconnection system that exerts force against the compliant linkage that offsets the stiffness induced by compliant linkage.

35. The joint of claim 34, wherein at least some of the first through fourth compliant revolute joints include resilient interconnection members that oppose the force exerted on the joints by the linkage as a result of transferring torque from the first independent link and the second independent link.

36. The joint of claim 34, wherein the resilient interconnection members exert negative stiffness against the first through fourth compliant revolute joints in opposition to positive stiffness exhibited by the joints.

37. The joint of claim 34, wherein the first through fourth compliant joints in combination with the resilient interconnection members exhibit substantially reduced stiffness behavior.

38. The joint of claim 34, wherein the first through fourth compliant revolute joints comprise rolling contact joints including rolling bodies that are in rolling contact with each other and resilient members that interconnect the rolling bodies so as to oppose the rolling motion of the rolling bodies.

39. The joint of claim 34, wherein the first through fourth compliant revolute joints comprise leaf spring interposed between two surfaces and wherein the first through fourth compliant revolute joint further are preloaded through linear or non-linear springs between the two surfaces that exert an opposite force of the force imposed on the leaf spring as a result of transmission of torque.

40. The joint of claim 34, wherein one or more linear or non-linear springs are attached between the linkage members exert force in opposition to the force exerted on the linkage as a result of torque being transmitted via the linkage from the first independent link to the second independent link.

41. The joint of claim 40, wherein a first crank member is interposed between the first and second compliant revolute joints and a second crank member is interposed between the third and fourth compliant revolute joint and wherein the springs extend between the drive shaft and the second crank link and the driven shaft and the first crank link.

42. The joint of claim 41, wherein the one or more spring is coupled between the first and second crank link.

43. The joint of claim 42, wherein the first crank link includes a first and a second pad and a leaf spring is coupled between the first and second pad and wherein a movable shuttle is coupled to the leaf spring and engages with the second crank link.

44. The joint of claim 26, wherein the first and second independent links respectively comprise a drive and a driven shaft.

45. The joint claim 30, wherein the twist angle β is zero

46. The joint of claim 26, wherein the structure has distributed compliance.

47. The joint of claim 26, wherein the joint comprises a plurality of compliant linkages and each compliant linkage is connected to each other with one or more springs with linear or nonlinear behavior.

48. The joint of claim 26, wherein the first and second independent links respectively comprise a drive and a driven shaft.

49. The joint of claim 26, wherein the first through fourth compliant revolute joints are arranged so that an axis of rotation of the first and second compliant revolute joints intersect each other at first location and an axis of rotation of the third and fourth compliant revolute joints intersect each other at second location that are respectively offset from the axis of rotation of the first and second independent links.

50. The joint of claim 26, wherein the joint comprises a plurality of compliant linkages and each compliant linkage is connected to each other with one or more springs with linear or nonlinear behavior.

51. The joint of claim 26, wherein the first through fourth compliant revolute joints include leaf spring members and wherein the second and third compliant revolute joints are attached to the leaf spring members of the first and fourth compliant revolute joints and wherein the coupler link is coupled to the leaf spring members of the second and third compliant revolute joints.

52. The joint of claim 26, wherein the joint exhibits two rotational degrees of freedom.
